(19) United States
(12) Patent Application Publication
(10) Pub. No.: US 2007/0029360 A1
(43) Pub. Date: Feb. 8, 2007

(54) Sun visor pen holder

(76) Inventors: Francis J. Connelly, Dunedin, FL (US); Sarah E. Connelly, Dunedin, FL (US)

Correspondence Address: LITMAN LAW OFFICES, LTD, PO BOX 15035, CRYSTAL CITY STATION, ARLINGTON, VA, 22215, US

(21) Appl. No.: 11/197,453

(22) Filed: Aug. 5, 2005

(51) Int. Cl. B60R 7/05

(52) U.S. Cl. 224/312

(57) ABSTRACT

The sun visor pen holder secures writing pens to the visor of a vehicle. The pen holder includes a main strap of an elastic material. The main strap forms a loop that stretches over the sun visor to secure the pen holder to the sun visor. A common lower loop adapted for retaining the point end of a plurality of pens extends transversely across the main strap. A plurality of upper loops extends across the main strap parallel to the lower loop, each pen loop forming a channel for holding the upper end of a single pen. A pen is inserted into the channel of an upper loop and slid under the lower loop to securing the pen to the holder at both the upper and lower ends of the pen.

### BACKGROUND OF THE INVENTION

1. Field of the Invention

The present invention relates to a storage device for organizing pens, and in particular to a pen holder for attaching to an automobile sun visor.

2. Description of the Related Art

Mobile devices, such as cellular telephones, laptop computers with wireless Internet connectivity, and paging devices have increased the expectation that business people will make themselves continuously available for contact. It is expected that even while commuting to work, or traveling between business stops, that travelers will be ready to conduct business just as if they were at their desks in the office.

An important part of conducting business is having a readily available writing utensil, such as a pen. Pens are useful for taking notes on business communications, plotting driving routes on a map, or for tracking items on a to-do list.

Writing utensils, such as pens, can be stored in the glove box, on the console, or on the dashboard of a vehicle, but using these storage locations can create problems. Pens left to rest loosely on the dashboard or console can move around as the car shifts, making the pen difficult to locate or to reach when the need arises. Pens left on the dashboard even may roll into vehicle ventilation ducts, making the pens practically impossible to retrieve. Loose items laying about the console or dashboard of the car also present a cluttered appearance that most drivers find unattractive.

Storing a pen in the glove box avoids clutter in the car and puts the pens in a fixed location, but also makes the pen difficult to retrieve during driving. When moving the vehicle on the roadways, and even while the vehicle is momentarily stopped at a signal light or in stalled traffic, it is important that a driver be attentive to road conditions and to other vehicles. It is desirable that a driver be able to retrieve a pen without unduly distracting the driver from the task of safely operating the vehicle.

Some drivers tuck pens and other items under the sun visors of their vehicles for easy retrieval. Simply tucking items under the visor fixes their locations, but allows the items to fall out when the driver needs to lower the visor to protect the driver's eyes from sunlight.

Some devices have been developed for attachment to sun visors. A representative device is shown in German Patent No. 2,332,613, published Jan. 16, 1975, which describes a device for attachment to a sun visor to increase the effective area for deflecting rays from the sun when the sun is low on the horizon. This reference is relevant to show the state of the regarding sun visor attachments, but does not address the same problems as the instant invention.

None of the above inventions and patents, taken either singly or in combination, is seen to describe the instant invention as claimed. Thus, a sun visor pen holder solving the aforementioned problems is desired.

### SUMMARY OF THE INVENTION

The sun visor pen holder secures writing pens to the visor of a vehicle. The pen holder includes a main strap of an elastic material formed into a loop. The strap stretches over the sun visor to secure the pen holder to the visor. The pen holder includes a common transverse lower loop capable of retaining the pen point end of a plurality of pens. The lower loop is attached across the width of the main strap. One or more straps form a plurality of upper loops, each upper loop forming a channel for retaining the upper end of a single pen body. A pen is inserted into the channel of an upper loop and slid under the lower loop to secure the pen to the visor at both the upper and lower ends of the pen.

The upper and lower pen loops may be made of a stretchable elastic or resilient fabric material so that the loops can stretch to accommodate pens of larger than standard diameters. Alternatively the pen loops can be constructed of an inelastic material, with the diameter of each channel being sized to accommodate a typical pen.

The upper loops may be formed of a single loop of material with the material of the upper loops attached along the length of the main strap with stitching to separate the single loop into individual channels forming the upper pen loops. Alternatively, the channels can be formed from individual loops of material for each upper pen loop attached to the main strap using stitching or any other attachment means.

These and other features of the present invention will become readily apparent upon further review of the following specification and drawings.

### BRIEF DESCRIPTION OF THE DRAWINGS

FIG. 1 is an environmental front view of a sun visor pen holder according to the present invention shown mounted on a sun visor with a plurality of pens in the holder.

FIG. 2 is an environmental perspective view of the sun visor pen holder shown from the side with a pen in the holder, the visor being omitted.

FIG. 3 is an environmental rear view of the sun visor pen holder of the present invention mounted to a sun visor.

FIG. 4 is an environmental perspective view of an empty sun visor pen holder according to the present invention mounted to a sun visor.

Similar reference characters denote corresponding features consistently throughout the attached drawings.

### DETAILED DESCRIPTION OF THE PREFERRED EMBODIMENTS

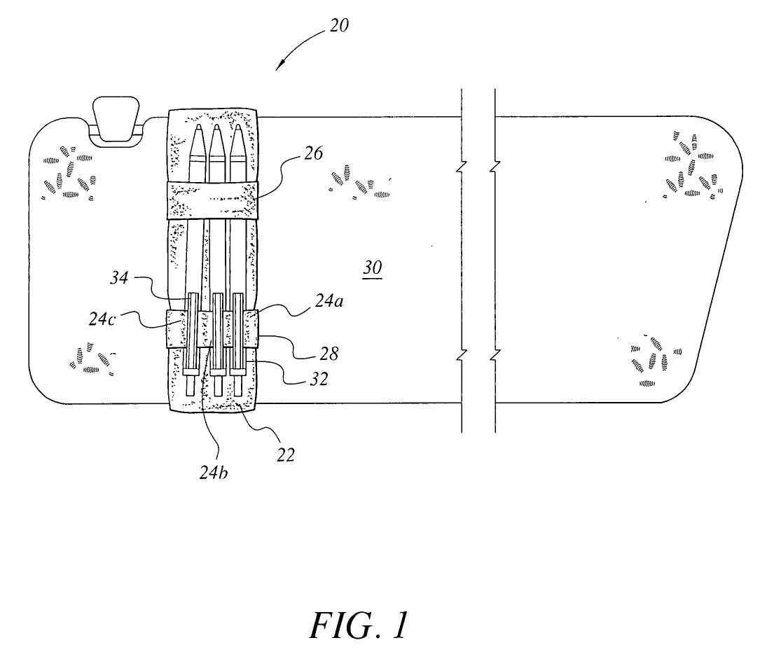

The present invention is a sun visor pen holder for holding a writing utensil, such as a pen, to the sun visor of a vehicle. The details of a pen holder in accordance with an embodiment of the invention can be understood by referring to FIGS. 1-4.

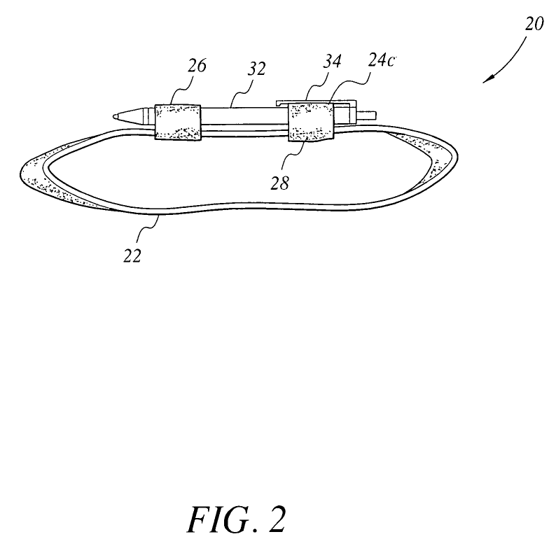

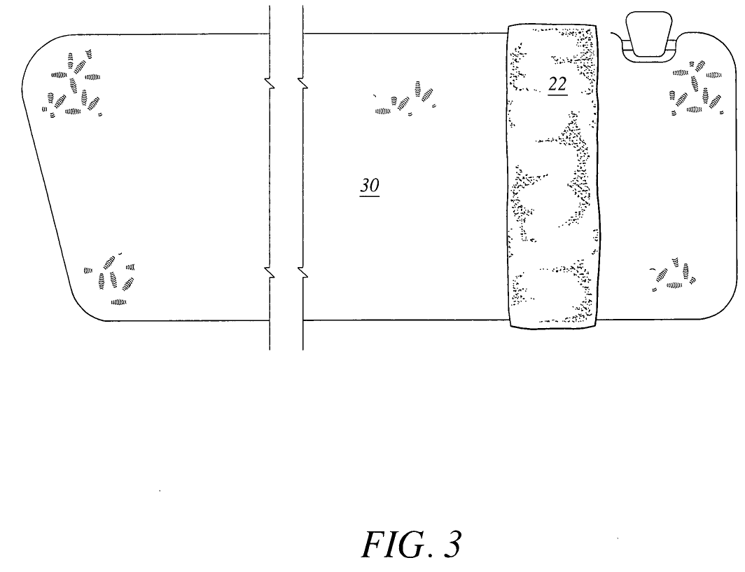

As shown in FIG. 1, the sun visor pen holder 20 has a main strap 22 that is adapted for attachment to a vehicle sun visor 30 using a strap 22. As best appreciated in FIG. 2, the elastic main strap 22 is a continuous band. The other components of the pen holder 20 are attached to the external surface of the band forming the main strap 22. The main strap 22 is made of an elastic material. The material is resilient and stretchable to accommodate the width of the sun visor 30, and when released contracts to hold the pen holder 20 firmly to the visor 30. As appreciated in FIGS. 1 and 3, the main strap 22 stretches around the sun visor 30 to hold the pen holder 20 to the visor 30.

Referring again to FIG. 1, it is appreciated that the embodiment of the invention can accommodate a plurality of pens, e.g., three pens 32. Each pen 32 is secured to the pen holder 20 using two pen securing devices. The first securing device is the common lower loop 26, which is a single loop of elastic material extending transversely across the main strap 22. The lower loop 26 is a common loop capable of retaining the lower or pen point end of all of the pens being held by the pen holder 20. As shown in FIG. 2, the ends of the lower loop 26 are secured to the surface of the main strap 22 that is on the interior of the main strap loop.

The lower ends of all of the pens held by the pen holder 20 are held in place by the resilience of the elastic band forming the lower loop 26. The upper ends of the pens 32 are secured by an upper loop 28 that extends transversely across the width of the main strap 22. As best appreciated by referring to FIG. 2, the ends of the upper loop 28 are attached to the surface of the main strap 22 that is on the interior of the main strap loop.

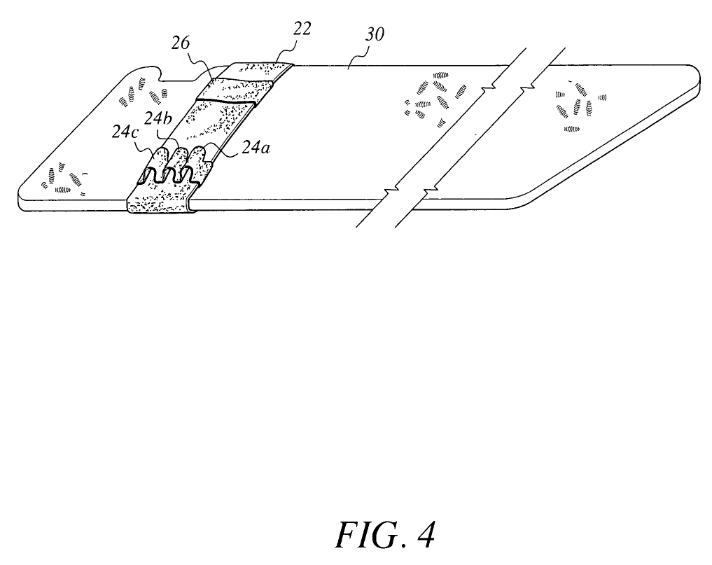

By referring to FIG. 4, details of the upper loop 28 may be appreciated. The upper loop 28 is formed into a plurality of individual pen loops 24a, 24b and 24c. Each of the pen loops 24a-24c forms a channel directed along the length of the main strap 22 and towards the lower loop 26. In the illustrated embodiment, three such pen loops 24a-24c are formed by using stitching, adhesive or other means to secure the upper loop 28 to the main strap 22. The pen loops 24a-24c are channels open on both ends. The channels of the pen loops 24a-24c are directed along the length of the upper surface of the main strap 22.

When a pen 32 (shown in FIG. 1) is inserted into one of the pen holder loops such as 24c, the channel of the pen loop 24c guides the pen towards the lower loop 26. The length of the channels formed by the pen loops 24a-24c is sufficient to ensure that when a pen 32 inserted into a pen loop 24c point first and slid towards the lower loop 26, the point of the pen 32 will be accurately guided to and under the lower loop 26. When the upper portion of a pen is inserted fully into the upper loop, the lower end of the pen 32 is held under the lower loop 26. Preferably the diameter of the pen loops 24a-24c is larger than that of a typical lower or pen point end of a pen, making it easy for a driver to insert the pen into a pen loop. The pen loops 24a-24c may be made of stretchable elastic fabric allowing the pen loops 24a-24c to accommodate pens larger of larger than typical diameter. Together the lower loop 26, and the upper pen holder loop 24a, 24b or 24c securely hold the pen 32 in place, as shown in FIGS. 1 and 2. As shown in FIG. 2, a clip 34 on the pen 32 may optionally extend over the top of the pen loop 24c, providing more secure attachment of the pen 32 to the holder 20.

The upper loop 28 and the lower loop 26 are substantially parallel, each extending across the width of the main strap 22. The separation distance between the upper loop 28 and the lower loop 26 is sufficiently short so that even relatively short pens will engage and be held by both loops. In one embodiment of the invention, the upper loop 28 is spaced two to three inches from the lower loop 26.

The pen holder 20 is constructed so that when pens are secured by the pen holder 20, the upper end of each pen is secured individually by the channel of an upper loop 24a-24c, and the pens are collective secured at the point end by the lower loop 26. The upper loops 24a-24c may be designed to loosely hold the pens, allowing a pen to be easily slid into the channel of the upper loop 24a-24c, while the resilience of the elastic material of the lower loop 26 is designed to hold the pen more tightly. Because the length of the lower loop 26 is relatively short, when retrieving a pen from the holder 20, only a short motion is needed to disengage the pen from the lower loop 26, making the pen easily removable from the holder 20. The result is a pen holder that allows pens to be easily inserted and removed, but which effectively secures the pens to the holder. The elastic band of the main strap 22 allows the pen holder to be snugly secured to sun visors of a variety of sizes.

The described pen holder 20 is shown holding three pens, but any number of pens may be accommodated.

In a preferred embodiment, the upper loops 24a-24c are formed from a single loop of material, the single loop of material divided by stitching into a plurality of individual loops. Alternatively, the plurality of upper loops 24a-24c can be made up of individual loops of material attached to the main strap 22 using stitching adhesive or other method. In an alternate embodiment, the upper loops 24a-24c may be constructed of an inelastic material with the opening of the loops sized to accommodate the diameter of typical pen.

Alternatively, the main strap 22 may be formed with sections of elastic and inelastic material. For example, the lower external surface of the strap 22 may be made of an elastic material while the upper external surface of the main strap 22 may be of an inelastic material.

In a representative embodiment, the pen holder 20 comprises three upper loops 24a-24c for holding three pens. The pen holder main strap 22 is approximately two inches wide and the unstretched circumference of the main strap 22 is approximately fourteen inches. The main strap 22, the upper loop 28, and the lower loop 26 are all made of an elastic, stretchable fabric material. The channels formed by the upper loops 24a-24c are approximately one inch in length, while the length of the lower loop 26 is approximately one inch. The upper loops 24a-24c and the lower loop 26 are separated by two or three inches. The dimensions of the example pen holder 20 are provided for enablement purposes only and do not limit the invention to the detailed dimensions and sizes.

It is to be understood that the present invention is not limited to the embodiments described above, but encompasses any and all embodiments within the scope of the following claims.

We claim:

1. A sun visor pen holder, comprising:
a main strap formed from a loop of elastic stretchable fabric material, the main strap being dimensioned and configured for resiliently encircling a sun visor;
a common lower loop adapted for holding a lower end of a plurality of pens, the lower loop extending transversely across the main strap; and
a plurality of upper loops attached to the main strap, the upper loops forming parallel pen channels adapted for receiving an upper end of a plurality of pens, the channels extending normal to the lower loop, whereby pens placed in the holder are individually retained at their upper end by the upper loops and commonly retained at their lower ends by the lower loop.

2. The sun visor pen holder according to claim 1, wherein each of the plurality of upper loops is made of an elastic fabric material.

3. The sun visor pen holder according to claim 1, wherein the plurality of upper loops are formed from a single upper strap having opposite ends fastened to the main strap and fastened to the main strap in parallel rows to form the plurality of pen channels.

4. The sun visor pen holder of claim 3, wherein the single upper strap is made of an elastic fabric material.

5. The sun visor pen holder of claim 3, further comprising parallel rows of stitching attaching the single upper strap to the main strap to form the parallel pen channels.

6. The sun visor pen holder of claim 3, further comprising parallel rows of adhesive joining the single upper strap to the main strap to form the parallel pen channels.
